(19) United States
(12) Patent Application Publication
(10) Pub. No.: US 2022/0129801 A1
(43) Pub. Date: Apr. 28, 2022

(54) PLANNING SUPPORT APPARATUS, PLANNING SUPPORT METHOD, AND PLANNING SUPPORT SYSTEM

(71) Applicant: HITACHI, LTD., Tokyo (JP)

(72) Inventor: Motonobu Saito, Tokyo (JP)

(73) Assignee: HITACHI, LTD., Tokyo (JP)

(21) Appl. No.: 17/422,800

(22) PCT Filed: Dec. 20, 2019
(86) PCT No.: PCT/JP2019/050041

§ 371 Date: Jul. 14, 2021

(30) Foreign Application Priority Data
Jan. 29, 2019 (JP) 2019-012900

(51) Int. Cl. G06Q 10/06; G06Q 50/04; G05B 19/418

(52) U.S. Cl. CPC G06Q 10/0633; G05B 2219/32088; G05B 19/41865; G06Q 50/04

(57) ABSTRACT

A planning support apparatus includes a storage device and a computing device. The storage device stores production record information, processing parameter information, and article attribute information for each of the articles. The production record information includes items of processes, facilities, articles, and production time. A computing device executes a process of generating a model for estimating the production time, a process of correcting production time under nonstandard conditions to production time under standard conditions on the basis of the model, and a process of generating a production time calculation formula for estimating production time from article attributes under the production conditions.

### TECHNICAL FIELD

The present invention relates to a planning support apparatus, a planning support method, and a planning support system, and more specifically to a technology for making it possible to efficiently estimate information about production time required for a production plan and achieve efficient production planning.

### BACKGROUND ART

In production planning, information, which serves as a basis for planning, about how long it will be required to perform processing articles in what type of facilities, that is, perform processes in what type of facilities is important for each combination of articles such as a product targeted for production and parts of the product, and processes such as machining and forging of the parts.

In view of the above circumstances, for example, a standard work time estimation apparatus (refer to Patent Document 1) is conventionally proposed so as to implement a technology based on the above point of view. The standard work time estimation apparatus includes: work-type-specific work time data classification means; attribute-item-value-specific work time data classification means; and breakdown work time calculation means. The work-type-specific work time data classification means generates work-type-specific work time data by classifying a plurality of pieces of work time data into work type item values indicating the type of work included in the plurality of pieces of work time data. The plurality of pieces of work time data includes at least item values that indicate attribute information about the type of work implemented, the work time required for the work, and the work, respectively. The attribute-item-value-specific work time data classification means generates attribute-item-value-specific work time data by further classifying the work-type-specific work time data into attribute item values of attribute information included in the work-type-specific work time data. On the basis of the attribute-item-value-specific work time data and with respect to each work-type-item-value-specific attribute item value included in the attribute-item-value-specific work time data, the breakdown work time calculation means calculates work time required for work corresponding to the work type item value and the attribute item value. The standard work time estimation apparatus estimates the work time calculated by the breakdown work time calculation means as standard work time required for the work corresponding to the work type item value and the attribute item value.

Further proposed is, for example, a production management system that provides production management of a product when the product is manufactured on a build-to-order basis. The production management system includes a management station that determines a standard specification coefficient of a standard part in accordance with at least drawing specifications. The standard specification coefficient is a specification coefficient that quantitatively indicates the ease of processing of each part included in the product. The management station further determines a new specification coefficient of a new part, regards the ratio between the standard specification coefficient and the new specification coefficient as a specification difference coefficient, regards the processing time required for the standard part as a standard time, calculates a new processing time representative of the processing time required for the new part on the basis of the standard time and the specification difference coefficient, and determines a production management process according to the standard time and the new processing time.

### CITATION LIST

### Patent Literature

Patent Document 1: JP-2015-148961-A

Patent Document 2: JP-2003-241823-A

### SUMMARY OF INVENTION

### Technical Problem

The above-mentioned information about production time can be easily calculated or estimated in a situation where a large number of articles are repeatedly produced in the same specifications. In recent years, however, the number of target data is intrinsically limited at a high-mix low-volume production site. Therefore, such calculation or estimation cannot easily be performed by using a convention method. Such a tendency is likely to be conspicuous particularly with respect to, for example, unprecedentedly produced articles and customized articles.

Consequently, when an attempt is made to formulate and execute a production plan under the above circumstances, production time estimation work based on the knowledge and past experience of a person in charge needs to be performed with respect to each article and each process and with respect to each facility. As a result, extremely complicated work needs to be individually performed. This causes an increase in human and economic costs, and makes it difficult to expect that accurate information about production time will be steadily obtained. Therefore, the above-mentioned work will hardly provide a pragmatic solution.

As such being the case, an object of the present invention is to provide a technology for making it possible to efficiently estimate information about production time required for a production plan and achieve efficient production planning.

### Solution to Problem

In order to solve the above problem, according to an aspect of the present invention, there is provided a planning support apparatus including a storage device and a computing device. The storage device stores production record information, processing parameter information, and article attribute information. The production record information includes items of processes, facilities, articles, and production time. The processing parameter information is set for the facilities under conditions indicated by the production record information. The article attribute information is information about each of the articles. The computing device executes: a process of making a statistical analysis of causal relation between processing parameters and production time under predetermined production conditions on the basis of the production record information and the processing parameter information, and generating a model for estimating the production time from the processing parameters; a process of correcting production time under nonstandard conditions to production time under predetermined standard conditions on the basis of the model, the production time under the standard conditions, and the production time under the nonstandard conditions, which correspond to the processing parameter information included in the production record information concerning the production conditions; and a process of making a statistical analysis of causal relation between article attributes and production time under the production conditions on the basis of the production time under the standard conditions concerning the production conditions and the article attribute information concerning the production conditions, and generating a production time calculation formula for estimating production time from article attributes.

According to another aspect of the present invention, there is provided a planning support method executed by an information processing apparatus including a storage device that stores production record information, processing parameter information, and article attribute information for each of articles. The production record information includes items of processes, facilities, articles, and production time. The processing parameter information is set for the facilities under conditions indicated by the production record information. The planning support method includes the steps of: executing a process of making a statistical analysis of causal relation between processing parameters and production time under predetermined production conditions on the basis of the production record information and the processing parameter information, and generating a model for estimating the production time from the processing parameters; executing a process of correcting production time under nonstandard conditions to production time under predetermined standard conditions on the basis of the model, the production time under the standard conditions, and the production time under the nonstandard conditions, which correspond to the processing parameter information included in the production record information concerning the production conditions; and executing a process of making a statistical analysis of causal relation between article attributes and production time under the production conditions on the basis of the production time under the standard conditions concerning the production conditions and the article attribute information concerning the production conditions, and generating a production time calculation formula for estimating production time from article attributes.

According to still another aspect of the present invention, there is provided a planning support system including at least a planning support apparatus and facilities. The planning support apparatus includes a storage device and a computing device. The storage device stores production record information, processing parameter information, and article attribute information for each of articles. The production record information includes items of processes, facilities, articles, and production time. The processing parameter information is set for the facilities under conditions indicated by the production record information. The computing device executes: a process of making a statistical analysis of causal relation between processing parameters and production time under predetermined production conditions on the basis of the production record information and the processing parameter information, and generating a model for estimating the production time from the processing parameters; a process of correcting production time under nonstandard conditions to production time under predetermined standard conditions on the basis of the model, the production time under the standard conditions, and the production time under the nonstandard conditions, which correspond to the processing parameter information included in the production record information concerning the production conditions; and a process of making a statistical analysis of causal relation between article attributes and production time under the production conditions on the basis of the production time under the standard conditions concerning the production conditions and the article attribute information concerning the production conditions, and generating a production time calculation formula for estimating production time from article attributes. The facilities, which are one or more facilities for which production time is calculated by the planning support apparatus, generate production record information and processing parameter information, and distribute the generated production record information and the generated processing parameter information to the planning support apparatus. The production record information includes items of processes, facilities, articles, and production time. The processing parameter information is set for the facilities under conditions indicated by the production record information.

### Advantageous Effects of Invention

The present invention makes it possible to efficiently estimate information about production time required for a production plan and achieve efficient production planning.

### BRIEF DESCRIPTION OF DRAWINGS

FIG. 1 is an overall configuration diagram illustrating a planning support system according to an embodiment of the present invention.

FIG. 2 is a diagram illustrating an example of configuration of a planning support apparatus according to the embodiment of the present invention.

FIG. 3 is a diagram illustrating an example of data structure of a production record DB according to the embodiment of the present invention.

FIG. 4 is a diagram illustrating an example of data structure of a processing parameter DB according to the embodiment of the present invention.

FIG. 5 is a diagram illustrating an example of data structure of an article attribute DB according to the embodiment of the present invention.

FIG. 6 is a diagram illustrating an example of data structure of a model DB according to the embodiment of the present invention.

FIG. 7 is a diagram illustrating an example of data structure of a production time calculation formula DB according to the embodiment of the present invention.

FIG. 8 is a diagram illustrating a first example of flow of a planning support method according to the embodiment of the present invention.

FIG. 9 is a diagram illustrating a second example of flow of the planning support method according to the embodiment of the present invention.

FIG. 10 is a diagram illustrating a first example of screen according to the embodiment of the present invention.

FIG. 11 is a diagram illustrating a second example of screen according to the embodiment of the present invention.

### DESCRIPTION OF EMBODIMENTS

### Example of System Configuration

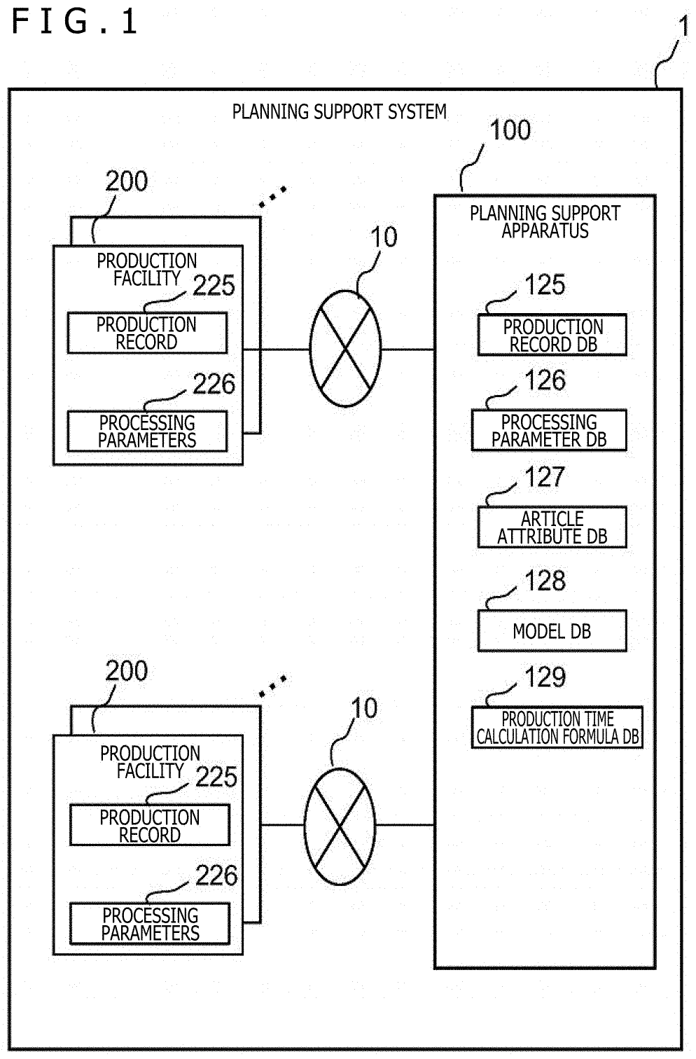

For example, the best mode for carrying out the present invention will now be described with reference to the accompanying drawings. FIG. 1 is a diagram illustrating an example of overall configuration of a planning support system 1 according to an embodiment of the present invention.

The planning support system 1 according to the present embodiment is an information processing system that is capable of efficiently estimating information about production time required for a production plan and achieving efficient production planning.

The planning support system 1 described above includes a planning support apparatus 100, one or more production facilities 200, and a network 10 for connecting the planning support apparatus 100 to the production facilities 200. It should be noted that the network 10 includes, for example, the wired LAN (Local Area Network) standard or the wireless LAN standard.

The planning support apparatus 100 is assumed to be, for example, a server or other PC, generates, for each combination of processes, facilities, and articles, a processing parameter change effect model for estimating the production time based on standard parameters of the facilities, corrects variations in the production time in a production record, according to the standard parameter, on the basis of the processing parameter change effect model, and generates a production time calculation formula for calculating the production time, according to article attributes.

It should be noted that the articles include a product targeted for production and its parts. Further, the processes are procedures for performing machining, grinding, shearing, forging, rolling, and various other processes on the articles targeted for production, in order to comply with specifications based on design requirements. Moreover, the article attributes include, for example, the length, thickness, and other dimensions of the articles, and the hardness, smoothness, toughness, and various other material properties of materials.

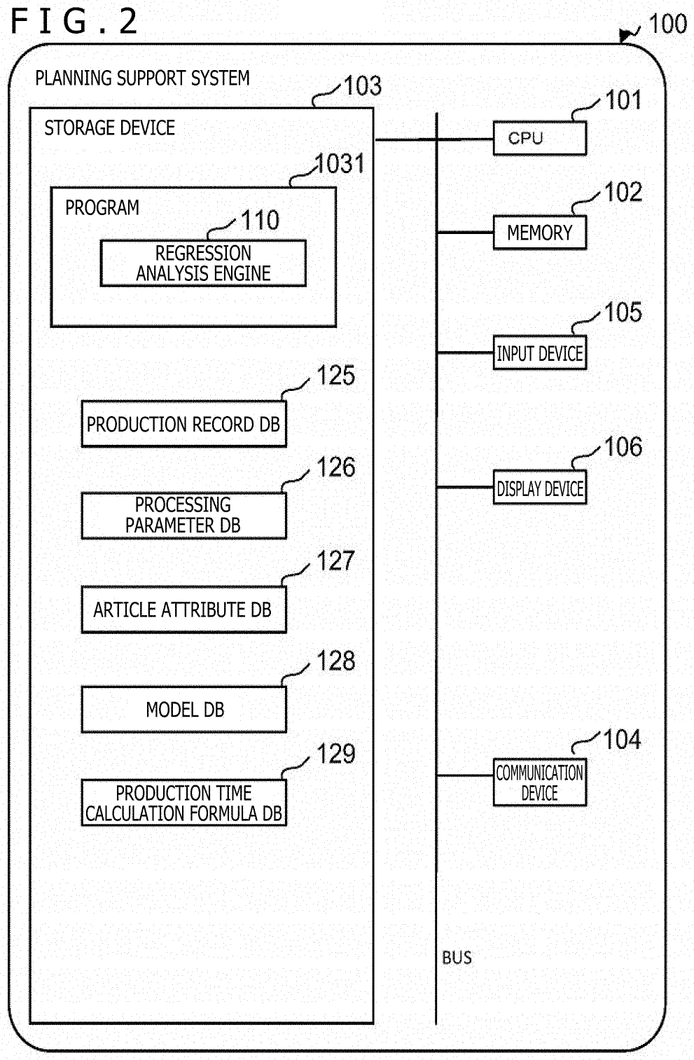

As depicted in an example of hardware configuration illustrated in FIG. 2, the planning support apparatus 100 described above includes a CPU 101 that acts as a computing device, a memory 102, a storage device 103, a communication device 104, an input device 105, and a display device 106.

It should be noted that the communication device 104 is an interface, such as a wired LAN card or a wireless LAN card, and communicates with the production facilities 200 through the network 10.

Further, the input device 105 is an input button, a touch panel, a keyboard, a mouse, or other device that allows a user to input various data to the planning support apparatus 100.

Moreover, the display device 106 is a liquid-crystal display or other device that allows the planning support apparatus 100 to display the results of processing to the user.

As regards the input device 105 and the display device 106, an alternative configuration may be adopted such that undepicted separate devices are connected to the planning support apparatus 100 through the network 10 and used as the input device and the display device.

Further, the storage device 103 is a hard disk, a flash memory, or other storage means formed by a nonvolatile storage element. It is assumed that the storage device 103 includes at least a regression analysis engine 110 as a stored program 1031. The regression analysis engine 110 is used to generate the processing parameter change effect model and the production time calculation formula, and uses an algorithm similar to an existing one.

It should be noted that the above-mentioned program 1031, which is stored in the storage device 103, executes its process when loaded into the memory 102 and executed by the CPU 101.

Further, it is assumed that the storage device 103 stores, as data, at least a production record DB 125, a processing parameter DB 126, an article attribute DB 127, a model DB 128, and a production time calculation formula DB 129 in addition to the above-mentioned program 1031. The structures of these DBs will be described in detail later.

It should be noted that the production facilities 200 connected to the above-mentioned network 10 is, for example, machine tools that perform machining, cutting, and various other processes on materials, semi-finished products, and other processing targets, generate a production record 225 descriptive of such processes and their results, and distribute the generated production record 225 to the planning support apparatus 100 through the network 10 in real time or in batch. The structure of the distributed production record 225 is similar to that of the production record DB 125.

### Data Structures of DBs

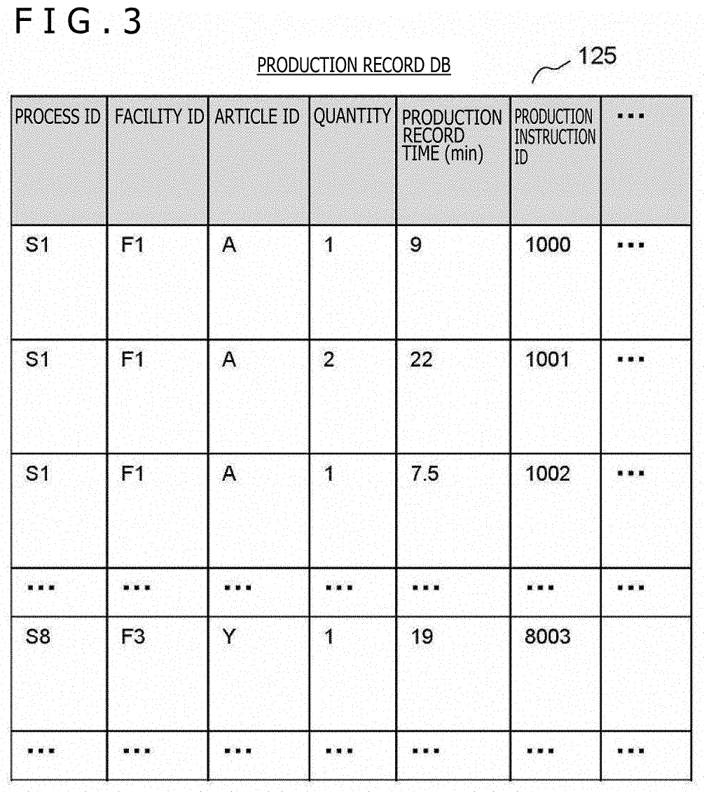

Examples of data structure of the DBs stored in the above-described storage device 103 will now be described in detail. FIG. 3 is a diagram illustrating an example of data structure of the production record DB 125 according to the present embodiment.

The production record DB 125 according to the present embodiment includes at least a process ID, a facility ID, an article ID, a quantity, a production record time (production time), and a production instruction ID as the fields of a record.

Each record in the above-described production record DB 125 makes it possible to grasp that values indicative of the quantity and the production record time are stored as a record of production performed in a production facility 200 indicated by the facility ID in relation to the combination of a process indicated by the process ID and an item indicated by the item ID.

Each record in the production record DB 125 is set on the basis of the production record 225 that is transmitted from a production facility 200 through the network 10. In this instance, the structure of the production record 225 transmitted and received between a production facility 200 and the planning support apparatus 100 is similar to that of the production record DB 125.

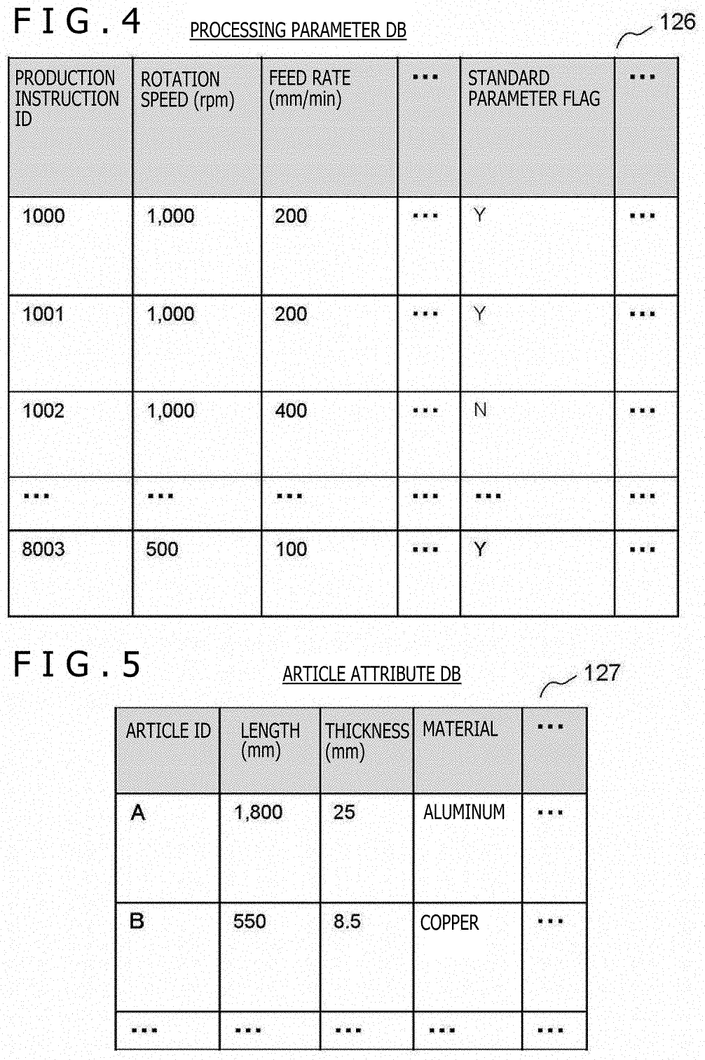

FIG. 4 is a diagram illustrating an example of data structure of the processing parameter DB 126 according to the present embodiment. The processing parameter DB 126 according to the present embodiment includes at least a production instruction ID, a rotation speed, a feed rate, and a standard parameter flag as the fields of a record.

Each record in the above-described processing parameter DB 126 makes it possible to grasp that actual values of the rotation speed, feed rate, and other processing parameters set in a production facility 200 are stored as the contents of a process performed on a relevant article under production conditions (process ID, facility ID, and article ID) that are linked to the production record DB 125 by using the production instruction ID as a key.

In an example indicated according to the present embodiment, the production facilities 200 are equipment for performing machining by bringing a cutting blade into contact with the surface of a member rotating at a constant rotation speed. It is assumed in the example that the member is fed at a rate for providing a predetermined amount of machining (i.e., at a feed rate) toward the above-mentioned cutting blade, and that the above-mentioned parameters are listed as items of the processing parameters for such machining.

Consequently, the above-mentioned items such as the rotation speed and the feed rate vary in presence and type depending, for example, on the specifications for the production facilities 200.

Further, each record in the processing parameter DB 126 is set on the basis of processing parameters 226 that are transmitted from the production facilities 200 through the network 10. In this instance, the structures of the processing parameters 226 transmitted and received between the production facilities 200 and the planning support apparatus 100 are similar to that of the processing parameter DB 126.

Additionally, the above-mentioned standard parameter flag indicates that the settings for the processing parameters, that is, items such as the rotation speed and feed rate indicated by a record for which the standard parameter flag is set, are standard values under production conditions defined by the combination of a process ID, facility ID, and article ID indicated by the production instruction ID.

FIG. 5 is a diagram illustrating an example of data structure of the article attribute DB 127 according to the present embodiment. As the fields of a record, the article attribute DB 127 according to the present embodiment includes at least an article ID and the attribute of an article identified by the article ID. The attribute of an article includes values indicating, for example, length, thickness, and material. However, it may be assumed that the attribute of an article includes, for example, a required quality level in addition to the above-mentioned length, thickness, and material.

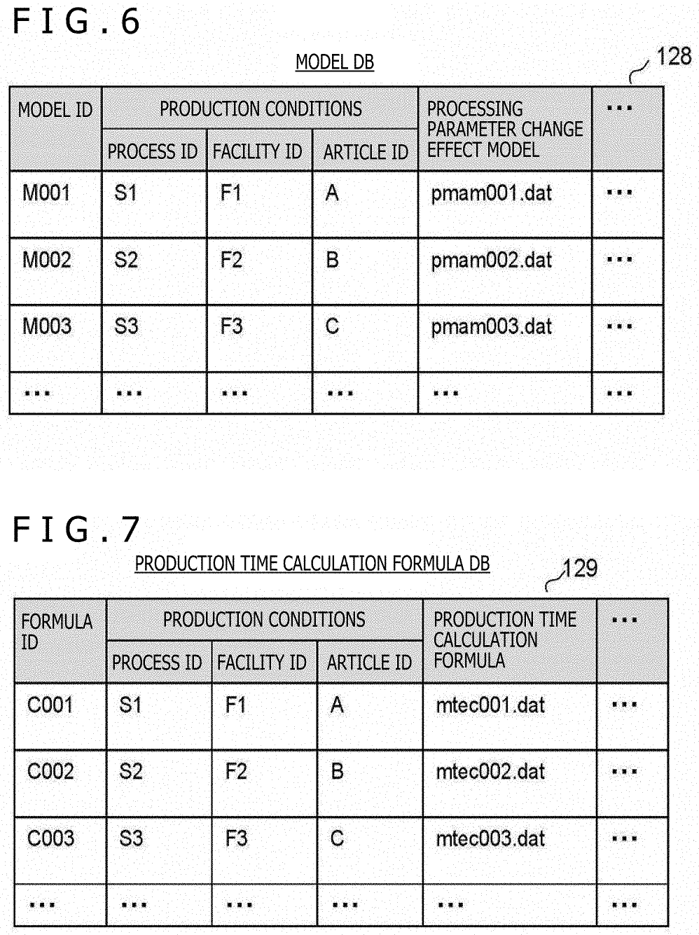

FIG. 6 is a diagram illustrating an example of data structure of the model DB 128 according to the present embodiment. As the fields of a record, the model DB 128 according to the present embodiment includes at least a model ID, production conditions including a process ID, a facility ID, and an item ID, and a processing parameter change effect model generated for the production conditions.

The processing parameter change effect model is generated by allowing the planning support apparatus 100 to make a statistical analysis of the causal relation between processing parameters and production time under predetermined production conditions on the basis of the production record DB 125 and the processing parameter DB 126.

FIG. 7 is a diagram illustrating an example of data structure of the production time calculation formula DB 129 according to the present embodiment. As the fields of a record, the production time calculation formula DB 129 according to the present embodiment includes at least a formula ID, production conditions including a process ID, a facility ID, and an article ID, and a production time calculation formula generated for the production conditions.

The production time calculation formula is generated by allowing the planning support apparatus 100 to correct production time under nonstandard conditions to production time under standard conditions on the basis of the processing parameter change effect model and the production time based on standard parameters and the production time based on nonstandard parameters, which correspond to the processing parameter information included in the production record information concerning the above-mentioned production conditions included in the production record DB 125, and to make a statistical analysis of the causal relation between article attributes and production time under the production conditions on the basis of the production time based on the standard parameters concerning the production conditions and the article attribute information concerning the production conditions.

### First Example of Flow

An actual sequence in the planning support method according to the present embodiment will now be described with reference to the accompanying drawings. Various operations based on the planning support method, which are described below, are implemented by the program that is loaded into memories of devices included in the planning support system 1 and executed. Then, the program is configured from codes for performing various operations described below.

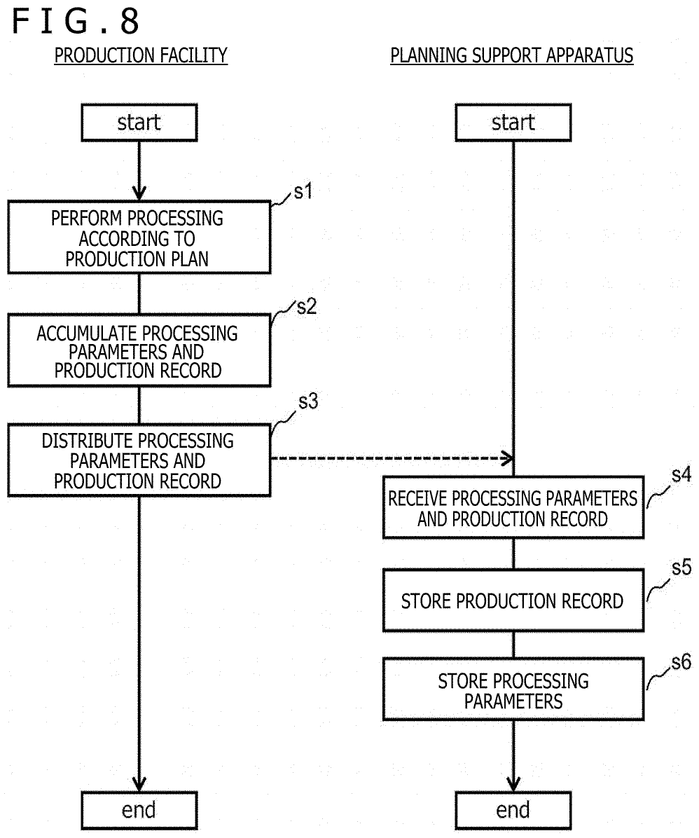

FIG. 8 is a diagram illustrating a first example of flow of the planning support method according to the present embodiment. In this example of flow, it is assumed that a production facility 200 has received and set processing parameters based on predetermined production plan data from the planning support apparatus 100 or its host apparatus (e.g., a production planning system). The above-mentioned processing parameters can be set or changed by an operator of an undepicted input device of the production facility 200.

In the above case, the production facility 200 operates according to the above-mentioned processing parameters that are already set, and performs predetermined processing on a processing target (e.g., a member or a semi-finished product) supplied from an upstream of a process (step s1).

The production facility 200 accumulates, in its own storage device, the values of the above-mentioned already set processing parameters as the processing parameters 226, and the contents (process, facility, and article) of actually performed processing as the production record 225 (step s2).

Subsequently, the production facility 200 distributes the production record 225 and processing parameters 226, which are stored in its own storage device, to the planning support apparatus 100 through the network 10 at predetermined time intervals or in batch mode (step s3).

Meanwhile, the planning support apparatus 100 receives the above-mentioned production record 225 and processing parameters 226 from the production facility 200 (step s4).

Further, the planning support apparatus 100 stores the production record 225, which is acquired in step s3, in the production record DB 125 (step s5). In addition, the planning support apparatus 100 similarly stores the processing parameters 226 in the processing parameter DB 126 (step s6), and then terminates the processing.

Performing the foregoing processing generates individual records of the production record DB 125 and processing parameter DB 126 in the planning support apparatus 100.

### Second Example of Flow

The following describes processing for generating the processing parameter change effect model and the production time calculation formula by using the production record DB 125 and the processing parameter DB 126, which are generated in the above-described manner.

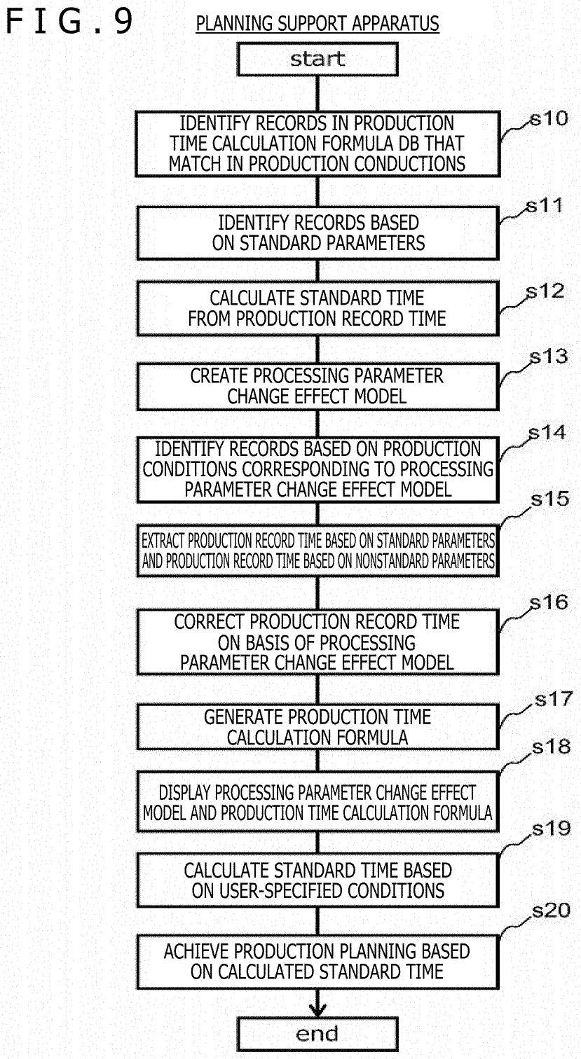

FIG. 9 is a diagram illustrating a second example of flow of the planning support method according to the present embodiment. In this example of flow, the planning support apparatus 100 identifies and groups records in the production record DB 125 that match in process ID, facility ID, and article ID (step s10). In the example of FIG. 3, at least three records having a process ID of “S1,” a facility ID of “F1,” and an article ID of “A” are identified as belonging to the same group.

Subsequently, the planning support apparatus 100 searches the processing parameter DB 126 by using, as a key, a production instruction ID indicated by the records identified in step s10, and identifies records having a standard parameter flag of “Y” (step s11). In the example of FIG. 4, two records having production instruction IDs of “1000” and “1001,” which are among three records having production instruction IDs of “1000” to “1002,” both have a standard parameter flag of “Y.”

Next, the planning support apparatus 100 extracts, from the production record DB 125, a production record time linked to the production instruction ID identified in step s11, executes predetermined statistical processing, for example, for calculating the average and median of the values of the extracted production record time, and thus calculates a standard time (step s12).

More specifically, referring to production instruction IDs of “1000” and “1001” in FIG. 3, the production instruction ID “1000” has a quantity of “1” and a production record time of “9”, whereas the production instruction ID “1001” has a quantity of “2” and a production record time of “22.” Therefore, when the average of these values is to be calculated, the factor of quantity is taken into consideration such that the production record time “22” of the production instruction ID “1001” is divided by 2 to obtain the value “11.” Then, the values “11” and “9” are averaged to obtain a standard time of “10.”

The above description assumes that the “standard parameter flag” is set for the records in the processing parameter DB 126. However, it is quite conceivable that there may arise a situation where no such flag is set.

In the above situation, the planning support apparatus 100 identifies records in the production record DB 125 that match in process ID, facility ID, and article ID, correspond to the records in the processing parameter DB 126 linked to a relevant production instruction ID, and have a frequency of appearance, namely, the quantity in the processing parameter DB 126, that exceeds a predetermined standard. A set of processing parameters of the records identified above is regarded as the standard parameters.

Alternatively, the planning support apparatus 100 may collate a production plan to be retained in association with the production record DB 125 and the processing parameter DB 126 with each record in the processing parameter DB 126, identify the records having the same values of processing parameter, and identify such processing parameters as the standard parameters. The reason is that the processing parameters identical with those in the production plan are presumed to be standard ones.

Subsequently, on the basis of the production record DB 125, the processing parameter DB 126, and the standard time obtained in step s12, the planning support apparatus 100 uses the regression analysis engine 110 to analyze the processing parameters and the correlation between the standard time and the production time under relevant production conditions (the process ID, facility ID, and article ID used as keys in step s10), generates the processing parameter change effect model for estimating the production time from the processing parameters (step s13), and stores the generated processing parameter change effect model in the model DB 128.

More specifically, the regression analysis engine 110 is allowed to make a multiple regression analysis by using the above-mentioned production time as an objective variable and the above-mentioned processing parameters (e.g., the rotation speed and the feed rate in the example of FIG. 4) and standard time as explanatory variables, and obtain a formula for the production time F that uses the processing parameters and the standard time as variables.

Subsequently, the planning support apparatus 100 references relevant records in the production record DB 125 by using, as a key, the production conditions concerning the processing parameter change effect model obtained in step s13 above, and then references records in the processing parameter DB 126 that are linked to the production instruction ID of the referenced relevant records (step s14).

Further, the planning support apparatus 100 identifies target records having a standard parameter flag of “Y” and target records having a standard parameter flag of “N,” which are found as a result of referencing in step s14, and extracts the production record time from records in the production record DB 125 by using production instruction IDs linked to the above-identified target records (step s15).

Subsequently, on the basis of the production record time based on the above-mentioned standard parameter flag “Y,” with the production record time based on the above-mentioned standard parameter flag “N,” and the processing parameter change effect model, the planning support apparatus 100 corrects the production record time under production conditions corresponding to records having the standard parameter flag “N” to the production record time under production conditions corresponding to records having the standard parameter flag “Y” (step s16).

For example, when the production record DB 125 is accessed to reference records linked to the production instruction ID “1002” having the standard parameter flag “N” under the above-mentioned production conditions (having a process ID of S1, a facility ID of F1, and an article ID of A), the production record time is found to be “7.5.” Further, when the processing parameter DB 126 is accessed to reference records linked to the production instruction ID “1002,” the feed rate is found to be “400.” Meanwhile, the production record DB 125 is accessed to reference records linked to the production instruction ID “1000” having the standard parameter flag “Y,” the production record time is found to be “9.” Moreover, when the processing parameter DB 126 is accessed to reference records linked to the production instruction ID “1000,” the feed rate is found to be “200.”

Contrastingly, when the formula for the processing parameter change effect model is production record time=standard time×feed rate/standard feed rate, it is conceivable, for example, that F=10×200/400=5.

Subsequently, on the basis of the production record time based on the standard parameters concerning the above-mentioned production conditions and the article attribute information (extracted from the article attribute DB 127) concerning the production conditions, the planning support apparatus 100 uses the regression analysis engine 110 to analyze the correlation between the attributes and production time of relevant articles, and generates the production time calculation formula for estimating the standard time from the attributes of the relevant articles (step s17). It is conceivable, for example, that the production time calculation formula is standard time=length of article A×5.

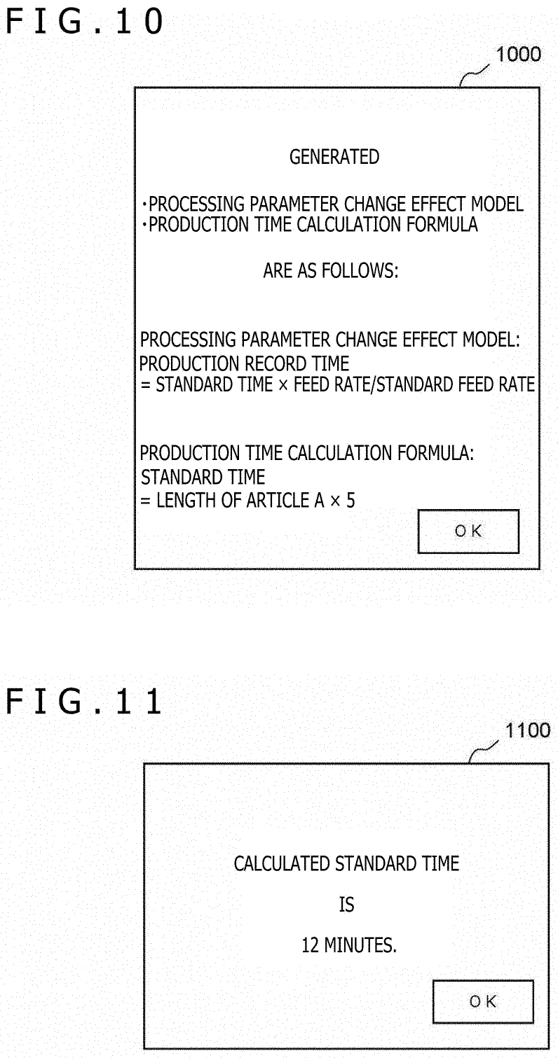

Next, the planning support apparatus 100 outputs, to the display device 106, the generated information about the above-mentioned processing parameter change effect model and production time calculation formula (refer to a screen 1000 in FIG. 10) (step s18).

Further, the planning support apparatus 100 receives designation of a process, a facility, and article attributes, from a user through the input device 105, accesses the production time calculation formula DB 129 to extract a generated production time calculation formula regarding the production conditions, and calculates the standard time (refer to a screen 1100 in FIG. 11) by applying the values of the article attributes designated from the user, to the production time calculation formula (step s19).

Moreover, the planning support apparatus 100 supplies the standard time obtained in step s19 to a predetermined production planning system to cause a production plan to be generated (step s20), and then terminates the processing.

It should be noted that the present invention is not limited to the foregoing embodiment and includes various modifications. For example, the foregoing embodiment has been described in detail in order to facilitate understanding of the present invention. The present invention is not necessarily limited to an embodiment that includes all of the above-described components.

Further, some components included in an embodiment may be replaced by other components. Furthermore, some components of an embodiment may be subjected to the addition of other components, deleted, or replaced by other components. Moreover, for example, the above-described components, functions, processing sections, and processing means may be partly or wholly implemented by hardware, that is, for example, by designing them with integrated circuits. Information regarding, for example, programs, tables, and files for implementing the individual functions may be stored in a recording device, such as a memory, a hard disk, or an SSD (Solid State Drive), or in a recording medium, such as an IC card, an SD card, or a DVD.

The present embodiment described above makes it possible to efficiently estimate information about production time required for a production plan and achieve efficient production planning.

At least the following is made apparent by the description in this document. In the planning support apparatus according to the present embodiment, when further executing a process of identifying the production record information corresponding to the processing parameter information concerning the standard conditions, performing a predetermined statistical process based on the production time indicated by each piece of the identified production record information, and calculating the standard time under the production conditions, and generating the model, the computing device may make a statistical analysis of the causal relation between the processing parameters and the standard time and the production time under the production conditions on the basis of the production record information, the processing parameter information, and the standard time, and generate the model for estimating the production time from the processing parameters.

The above alternative configuration makes it possible to generate the model based on information indicating that the production time is the standard time. As a result, the information about the production time required for a production plan can be estimated more efficiently to achieve efficient production planning.

Further, in the planning support apparatus according to the present embodiment, the computing device may further execute a process of outputting information about the model and the production time calculation formula to a predetermined device.

The above alternative configuration makes it easy for the user such as a production planner to recognize the model and production time calculation formula for use in the user's own production planning and conduct well-grounded planning work. As a result, the information about the production time required for a production plan can be estimated more efficiently to achieve efficient production planning.

Further, in the planning support apparatus according to the present embodiment, when generating the model, the computing device may identify processing parameters linked to the predetermined production conditions and appearing with a frequency equal to or higher than a predetermined frequency, as the standard parameters on the basis of the production record information and the processing parameter information, make a statistical analysis of the causal relation between the processing parameters and the production time under the predetermined production conditions linked to the standard parameters, and generate the model for estimating the production time from the processing parameters.

The above alternative configuration makes it possible to efficiently and accurately identify standard parameters and utilize them for model generation even in a situation where information about the standard parameters is not included in the processing parameter information. As a result, the information about the production time required for a production plan can be estimated more efficiently to achieve efficient production planning.

Further, in the planning support apparatus according to the present embodiment, the storage device further stores production plan information regarding a production process that uses the facility, and when generating the model, the computing device may identify the production plan information and the processing parameter information that share the same values of processing parameter information, identify relevant processing parameters as standard parameters, make a statistical analysis of the causal relation between the processing parameters and the production time under the predetermined production conditions linked to the standard parameters, and generate the model for estimating the production time from the processing parameters.

The above alternative configuration makes it possible to efficiently and accurately identify standard parameters and utilize them for model generation even in a situation where information about the standard parameters is not included in the processing parameter information. As a result, the information about the production time required for a production plan can be estimated more efficiently to achieve efficient production planning.

Further, in the planning support apparatus according to the present embodiment, the computing device may further execute a process of: receiving designation of a process, a facility, and article attributes from a user through the input device; calculating the production time by applying the values of the article attributes designated from the user, to the generated production time calculation formula regarding the production conditions; and supplying the calculated production time to a predetermined production planning system to cause a production plan to be generated.

The above alternative configuration makes it possible to efficiently calculate a production time and thus achieve production planning by using the calculated production time. As a result, the information about the production time required for a production plan can be estimated more efficiently to achieve efficient production planning.

Further, in the planning support method according to the present embodiment, when further executing a process of identifying the production record information corresponding to the processing parameter information concerning the standard conditions, performing a predetermined statistical process based on the production time indicated by each piece of the identified production record information, and calculating the standard time under the production conditions, and generating the model, the information processing apparatus may make a statistical analysis of the causal relation between the processing parameters and the standard time and the production time under the production conditions on the basis of the production record information, the processing parameter information, and the standard time, and generate the model for estimating the production time from the processing parameters.

Furthermore, in the planning support method according to the present embodiment, the information processing apparatus may further execute a process of outputting information about the model and information about the production time calculation formula to a predetermined device.

Moreover, in the planning support method according to the present embodiment, in a case where the information processing apparatus generates the model, the planning support method may include the steps of: identifying processing parameters linked to the predetermined production conditions and appearing with a frequency equal to or higher than a predetermined frequency, as the standard parameters on the basis of the production record information and the processing parameter information; making a statistical analysis of the causal relation between the processing parameters and the production time under the predetermined production conditions linked to the standard parameters; and generating the model for estimating the production time from the processing parameters.

Additionally, in the planning support method according to the present embodiment, in a case where the information processing apparatus causes the storage device to further store production plan information regarding a production process using the facility and to generate the model, the planning support method may include the steps of: identifying the production plan information and the processing parameter information that share the same values of processing parameter information; identifying relevant processing parameters as standard parameters; making a statistical analysis of the causal relation between the processing parameters and the production time under the predetermined production conditions linked to the standard parameters; and generating the model for estimating the production time from the processing parameters.

In addition, in the planning support method according to the present embodiment, the information processing apparatus may further execute a process of: receiving designation of a process, a facility, and article attributes, from a user through the input device; calculating the production time by applying the values of the article attributes designated from the user, to the generated production time calculation formula regarding the production conditions; and supplying the calculated production time to a predetermined production planning system to cause a production plan to be generated.

### REFERENCE SIGNS LIST

1: Planning support system
10: Network
100: Planning support apparatus
101: CPU
102: Memory
103: Storage device
1031: Program
104: Communication device
105: Input device
106: Display device
110: Regression analysis engine
125: Production record DB
126: Processing parameter DB
127: Article attribute DB
128: Model DB
129: Production time calculation formula DB
200: Production facility
225: Production record
226: Processing parameters

1. A planning support apparatus comprising:
a storage device that stores production record information, processing parameter information, and article attribute information for each of articles, the production record information including items of processes, facilities, the articles, and production time, the processing parameter information being set for the facilities under conditions indicated by the production record information; and
a computing device that executes a process of making a statistical analysis of causal relation between processing parameters and production time under predetermined production conditions on a basis of the production record information and the processing parameter information, and generating a model for estimating the production time from the processing parameters, a process of correcting production time under nonstandard conditions to production time under predetermined standard conditions on a basis of the model, the production time under the standard conditions, and the production time under the nonstandard conditions, the standard and nonstandard conditions corresponding to the processing parameter information included in the production record information concerning the production conditions, and a process of making a statistical analysis of causal relation between article attributes and production time under the production conditions on a basis of the production time under the standard conditions concerning the production conditions and the article attribute information concerning the production conditions, and generating a production time calculation formula for estimating production time from article attributes.

2. The planning support apparatus according to claim 1, wherein
the computing device further executes a process of identifying the production record information corresponding to the processing parameter information concerning the standard conditions, performing a predetermined statistical process based on the production time indicated by each piece of the identified production record information, and calculating standard time under the production conditions, and
when generating the model, the computing device makes a statistical analysis of the causal relation between the processing parameters and the standard time and the production time under the production conditions on a basis of the production record information, the processing parameter information, and the standard time, and generates the model for estimating the production time from the processing parameters.

3. The planning support apparatus according to claim 1, wherein
the computing device further executes a process of outputting information about the model and the production time calculation formula to a predetermined device.

4. The planning support apparatus according to claim 1, wherein
when generating the model, the computing device identifies the processing parameters linked to the predetermined production conditions and appearing with a frequency equal to or higher than a predetermined frequency, as standard parameters on a basis of the production record information and the processing parameter information, makes a statistical analysis of the causal relation between the processing parameters and the production time under the predetermined production conditions linked to the standard parameters, and generates the model for estimating the production time from the processing parameters.

5. The planning support apparatus according to claim 1, wherein
the storage device further stores production plan information regarding a production process that uses the facility, and
when generating the model, the computing device identifies the production plan information and the processing parameter information that share same values of processing parameter information, identifies relevant processing parameters as the standard parameters, makes a statistical analysis of the causal relation between the processing parameters and the production time under the predetermined production conditions linked to the standard parameters, and generates the model for estimating the production time from the processing parameters.

6. The planning support apparatus according to claim 1, wherein
the computing device further executes a process of receiving designation of a process, a facility, and article attributes, from a user through an input device, calculating the production time by applying values of the article attributes designated from the user, to the generated production time calculation formula regarding the production conditions, and supplying the calculated production time to a predetermined production planning system to cause a production plan to be generated.

7. A planning support method executed by an information processing apparatus including a storage device that stores production record information, processing parameter information, and article attribute information for each of articles, the production record information including items of processes, facilities, the articles, and production time, the processing parameter information being set for the facilities under conditions indicated by the production record information, the planning support method comprising the steps of:
executing a process of making a statistical analysis of causal relation between processing parameters and production time under predetermined production conditions on a basis of the production record information and the processing parameter information, and generating a model for estimating the production time from the processing parameters;
executing a process of correcting production time under nonstandard conditions to production time under predetermined standard conditions on a basis of the model, the production time under the standard conditions, and the production time under the nonstandard conditions, the standard and nonstandard conditions corresponding to the processing parameter information included in the production record information concerning the production conditions; and
executing a process of making a statistical analysis of causal relation between article attributes and production time under the production conditions on a basis of the production time under the standard conditions concerning the production conditions and the article attribute information concerning the production conditions, and generating a production time calculation formula for estimating production time from article attributes.

8. The planning support method according to claim 7, wherein
the information processing apparatus, further executes a process of identifying the production record information corresponding to the processing parameter information concerning the standard conditions, performing a predetermined statistical process based on the production time indicated by each piece of the identified production record information, and calculating standard time under the production conditions, and
the information processing apparatus, when generating the model, makes a statistical analysis of the causal relation between the processing parameters and the standard time and the production time under the production conditions on a basis of the production record information, the processing parameter information, and the standard time, and generates the model for estimating the production time from the processing parameters.

9. The planning support method according to claim 7, wherein
the information processing apparatus further executes a process of outputting information about the model and the production time calculation formula to a predetermined device.

10. The planning support method according to claim 7, wherein
the information processing apparatus, when generating the model, identifies the processing parameters linked to the predetermined production conditions and appearing with a frequency equal to or higher than a predetermined frequency, as standard parameters on a basis of the production record information and the processing parameter information, makes a statistical analysis of the causal relation between the processing parameters and the production time under the predetermined production conditions linked to the standard parameters, and generates the model for estimating the production time from the processing parameters.

11. The planning support method according to claim 7, wherein
the information processing apparatus, further stores, in the storage device, production plan information regarding a production process that uses the facility, and
the information processing apparatus, when generating the model, identifies the production plan information and the processing parameter information that share same values of processing parameter information, identifies relevant processing parameters as the standard parameters, makes a statistical analysis of the causal relation between the processing parameters and the production time under the predetermined production conditions linked to the standard parameters, and generates the model for estimating the production time from the processing parameters.

12. The planning support method according to claim 7, wherein
the information processing apparatus further executes a process of receiving designation of a process, a facility, and article attributes, from a user through an input device, calculating the production time by applying the values of the article attributes designated from the user, to the generated production time calculation formula regarding the production conditions, and supplying the calculated production time to a predetermined production planning system to cause a production plan to be generated.

13. A planning support system comprising:
at least a planning support apparatus and facilities,
the planning support apparatus including
a storage device that stores production record information, processing parameter information, and article attribute information for each of articles, the production record information including items of processes, facilities, the articles, and production time, the processing parameter information being set for the facilities under conditions indicated by the production record information, and
a computing device that executes a process of making a statistical analysis of causal relation between processing parameters and production time under predetermined production conditions on a basis of the production record information and the processing parameter information, and generating a model for estimating the production time from the processing parameters, a process of correcting production time under nonstandard conditions to production time under predetermined standard conditions on a basis of the model, the production time under the standard conditions, and the production time under the nonstandard conditions, the standard and nonstandard conditions corresponding to the processing parameter information included in the production record information concerning the production conditions, and a process of making a statistical analysis of causal relation between article attributes and production time under the production conditions on a basis of the production time under the standard conditions concerning the production conditions and the article attribute information concerning the production conditions, and generating a production time calculation formula for estimating production time from article attributes,
the facilities being one or more facilities for which production time is calculated by the planning support apparatus, generating production record information and processing parameter information, and distribute the generated production record information and the generated processing parameter information to the planning support apparatus, the production record information including items of processes, facilities, articles, and production time, the processing parameter information being set for the facilities under conditions indicated by the production record information.
